(19) United States
(12) Patent Application Publication
(10) Pub. No.: US 2026/0089460 A1
(43) Pub. Date: Mar. 26, 2026

(54) METHOD FOR MATCHING LEFT AND RIGHT CHANNELS OF EARPHONES, CLIP-ON EARPHONES AND STORAGE MEDIUM

(71) Applicant: GOERTEK INC., Weifang (CN)

(72) Inventors: Haiyong WANG, Weifang (CN); Bin JIANG, Weifang (CN)

(21) Appl. No.: 19/404,673

(22) Filed: Dec. 1, 2025

Related U.S. Application Data
(63) Continuation of application No. PCT/CN2025/084578, filed on Mar. 25, 2025.

(30) Foreign Application Priority Data
Mar. 28, 2024 (CN) 202410371075.4

(51) Int. Cl. H04S 7/00; H04R 1/10

(52) U.S. Cl. CPC H04S 7/304; H04R 1/1041

(57) ABSTRACT

A method for matching left and right channels of earphones, a clip-on earphone, and a computer-readable storage medium. The method includes: obtaining, in response to detecting that the target earphone is worn, three-axis acceleration information detected by the three-axis acceleration sensor and a sensed fingerprint detected by the fingerprint sensor, where the target earphone is a first earphone or a second earphone in the clip-on earphone; and adjusting, according to the three-axis acceleration information and the sensed fingerprint, a channel of a speaker of the target earphone to make a channel of the target earphone match a wearing position.

### CROSS-REFERENCE TO RELATED APPLICATIONS

This application is a continuation application of International Application No. PCT/CN2025/084578, filed on Mar. 25, 2025, which claims priority to Chinese Patent Application No. 202410371075.4, filed on Mar. 28, 2024. All of the aforementioned applications are incorporated herein by reference in their entireties.

### TECHNICAL FIELD

The present application relates to the technical field of earphone, and in particular to a method for matching left and right channels of an earphone, a clip-on earphone, and a storage medium.

### BACKGROUND

With the development of new technologies, open wearable stereo (OWS) earphones, such as clip-on earphones, are becoming increasingly popular. Compared to true wireless stereo (TWS) earphones, clip-on earphones are more ear-friendly, hearing-safe, comfortable to wear, and more suitable for extended wear. Because clip-on earphones don't need to be worn in the ear, they can be worn in both ears, ensuring a consistent fit and a universal fit, unlike traditional earphones.

The clip-on earphones include a left earphone and a right earphone. The left earphone outputs a left channel, while the right earphone outputs a right channel. When the stereo earphones are worn, the left earphone is in contact with the user's left ear, and the right earphone is in contact with the user's right ear, so that the left ear receives the left channel and the right ear receives the right channel. During wearing, the relative positions of the left earphone and the right earphone cannot be interchanged, otherwise it will directly affect the fidelity of the sound source and the resolution of the audio frequency.

To achieve perfect sound quality, users must first identify the left and right earphones of their clip-on earphones before putting them on. In the related art, the clip-on earphones are marked with identifiers such as “L” and “R.” However, this requires manual identification before wearing to avoid reversed placement, which brings inconvenience to the user.

### SUMMARY

The main purpose of the present application is to provide a method for matching the left and right channels of earphones, a clip-on earphone and a storage medium, aiming to solve the technical problem in the related art that manual confirmation is required to determine whether the left and right earphones are worn reversed, resulting in poor convenience in using clip-on earphones.

To achieve the above objectives, the present application provides a method for matching left and right channels of earphones. The method is applied to a clip-on earphone, a target earphone of the clip-on earphone is provided with a three-axis acceleration sensor and a fingerprint sensor. The method includes:
obtaining, in response to detecting that the target earphone is worn, three-axis acceleration information detected by the three-axis acceleration sensor and a sensed fingerprint detected by the fingerprint sensor, the target earphone is a first earphone or a second earphone in the clip-on earphone; and
adjusting, according to the three-axis acceleration information and the sensed fingerprint, a channel of a speaker of the target earphone to make a channel of the target earphone match a wearing position.

In an embodiment, the adjusting, according to the three-axis acceleration information and the sensed fingerprint, the channel of the speaker of the target earphone includes:
determining the wearing position corresponding to the target earphone based on the three-axis acceleration information and the sensed fingerprint; and
based on the wearing position corresponding to the target earphone, adjusting the channel of the speaker of the target earphone to make the left channel of the target earphone correspond to a left ear wearing position, and/or the right channel of the target earphone correspond to a right ear wearing position.

In an embodiment, the determining the wearing position corresponding to the target earphone based on the three-axis acceleration information and the sensed fingerprint includes:
determining a direction of vertical component of the three-axis acceleration information;
matching the sensed fingerprint in a pre-stored fingerprint database to obtain a matching fingerprint corresponding to the sensed fingerprint, and determining fingerprint registration information associated with the matching fingerprint;
determining touching hand information to which the sensed fingerprint belongs based on the fingerprint registration information; and determining the wearing position corresponding to the target earphone according to the fingerprint registration information and the touching hand information.

In an embodiment, the determining the wearing position corresponding to the target earphone according to the fingerprint registration information and the touching hand information includes:

in response to determining that the touching hand information corresponds to a left hand, and the direction of vertical component of the three-axis acceleration information points to a positive direction of a Z axis, determining the wearing position corresponding to the target earphone is a left ear; and
in response to determining that the touching hand information corresponds to a right hand, and the direction of vertical component of the three-axis acceleration information points to a negative direction of the Z axis, determining the wearing position corresponding to the target earphone is a right ear.

In an embodiment, the method further includes:
in response to determining that the touching hand information corresponds to a right hand and the direction of vertical component of the three-axis acceleration information points to a positive direction of a Z axis, or in response to determining that the touching hand information corresponds to a left hand and the direction of vertical component of the three-axis acceleration information points to a negative direction of the Z axis, determining a value of vertical component of the three-axis acceleration information; and
determining the wearing position corresponding to the target earphone according to the direction of vertical component and the value of vertical component.

In an embodiment, the determining the wearing position corresponding to the target earphone according to the direction of vertical component and the value of vertical component includes:
in response to determining that the direction of vertical component of the three-axis acceleration information points to the positive direction of the Z axis and the value of vertical component matches a gravity acceleration value, determining the wearing position corresponding to the target earphone is a left ear; and
in response to determining that the direction of vertical component of the three-axis acceleration information points to the negative direction of the Z axis and the value of vertical component matches the gravity acceleration value, determining the wearing position corresponding to the target earphone is a right ear.

In an embodiment, the after determining the value of vertical component of the three-axis acceleration information, the method further includes:
in response to determining that the value of vertical component matches a gravity acceleration value, determining the wearing position corresponding to the target earphone according to the direction of vertical component and the value of vertical component; and
in response to determining that the value of vertical component does not match the gravity acceleration value, determining the wearing position corresponding to a reference earphone; determining the wearing position corresponding to the target earphone based on a wearing position corresponding to the reference earphone, the reference earphone is an earphone of another channel in the clip-on earphone corresponding to the target earphone.

In an embodiment, the determining the wearing position corresponding to the target earphone based on the wearing position corresponding to the reference earphone includes:
in response to determining that the wearing position corresponding to the reference earphone is a left ear, determining the wearing position corresponding to the target earphone is a right ear; and
in response to determining that the wearing position corresponding to the reference earphone is the right ear, determining the wearing position corresponding to the target earphone is the left ear.

In an embodiment, the matching the sensed fingerprint with the pre-stored fingerprint database to obtain the matching fingerprint corresponding to the sensed fingerprint includes:
matching the sensed fingerprint with registered fingerprints in the pre-stored fingerprint database; and
in response to determining that a feature matching rate between the registered fingerprint and the sensed fingerprint is greater than a preset ratio threshold, using the registered fingerprint with the feature matching rate greater than the preset ratio threshold as the matching fingerprint corresponding to the sensed fingerprint.

In an embodiment, the target earphone includes a speaker compartment and a behind-the-ear compartment, and the fingerprint sensor includes a fingerprint detection sensing strip for fingerprint area sensing, and the fingerprint detection sensing strip is provided at a surface of the speaker compartment and/or the behind-the-ear compartment.

The present application further provides a clip-on earphone, including:
a memory, a processor, a fingerprint sensor, a behind-the-ear compartment, a speaker compartment, and a connecting bridge connecting the behind-the-ear compartment and the speaker compartment, wherein:
the speaker compartment is provided with an acoustic module including a speaker, the behind-the-ear compartment is provided with a power module and an acceleration sensor, and the fingerprint sensor is provided in the speaker compartment and/or the behind-the-ear compartment;
the power module is configured to provide power to the clip-on earphone;
the acceleration sensor is configured to detect the three-axis acceleration information of the clip-on earphone;
the fingerprint sensor is configured to detect the sensed fingerprint;
the memory is configured to store a program for matching left and right channels of earphones;
the processor is configured to execute the program for matching left and right channels of earphones, and implement the method for matching left and right channels of earphones as described above when executing the program for matching left and right channels of earphones.

The present application further provides a computer program product, including a computer program, which implements the steps of the above-mentioned method for matching left and right channels of earphones when executed by a processor.

The present application further provides a non-transitory computer-readable storage medium, on which a program for implementing a method for matching left and right channels of earphones is stored, wherein when the program for implementing the method for matching left and right channels of earphones is executed by a processor, the method for matching left and right channels of earphones as described above is implemented.

The present application provides a method for matching left and right channels of earphones, a clip-on earphone and a storage medium. The method for matching left and right channels of earphones is applied to the clip-on earphone. The target earphone of the clip-on earphone is provided with a three-axis acceleration sensor and a fingerprint sensor. The technical solution of the method for matching left and right channels of earphones of the present application includes: in response to detecting that the target earphone is worn, obtaining three-axis acceleration information detected by the three-axis acceleration sensor and a sensed fingerprint detected by the fingerprint sensor, the target earphone is a first earphone or a second earphone in the clip-on earphone; and according to the three-axis acceleration information and the sensed fingerprint, adjusting a channel of a speaker of the target earphone to make a channel of the target earphone match a wearing position. That is, the left channel of the target earphone corresponds to the left ear wearing position, and the right channel of the target earphone corresponds to the right ear wearing position, thereby realizing automatic matching of the left and right channels with the left and right ears, overcoming the inconvenience caused by marking, for example, the earphones are marked with identifiers such as “L” and “R” in the related art, which requires manual confirmation to ensure that they are not worn reversed, thereby improving the convenience of using clip-on earphones, and effectively realizing The method effectively enables users to wear earphones without distinguishing between the left and right channels in advance, ensuring that the audio signals of the left and right channels are always correct regardless of how the clip-on earphones are worn, thereby improving the user's auditory experience.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the technical solutions in this embodiment or the related art, the following briefly introduces the drawings required for use in the embodiment or the description of the related art. Obviously, for those skilled in the art, other drawings can be obtained based on these drawings without any creative work.

FIG. 1 is a flow chart of a method for matching left and right channels of earphones according to a first embodiment of the present application.

FIG. 2 is the clip-on earphone according to an embodiment of the present application from one perspective.

FIG. 3 is the clip-on earphone according to an embodiment of the present application from another perspective.

FIG. 4 is a low chart of the method for matching left and right channels of earphones according to the first embodiment of the present application.

FIG. 5 is a low chart of the method for matching left and right channels of earphones according to the first embodiment of the present application.

FIG. 6 is a low chart of the method for matching left and right channels of earphones according to the first embodiment of the present application.

FIG. 7 is a low chart of the method for matching left and right channels of earphones according to the first embodiment of the present application.

FIG. 8 is a low chart of the method for matching left and right channels of earphones according to the first embodiment of the present application.

FIG. 9 is a low chart of the method for matching left and right channels of earphones according to a second embodiment of the present application.

FIG. 10 is a low chart of the method for matching left and right channels of earphones according to the second embodiment of the present application.

FIG. 11 is a low chart of the method for matching left and right channels of earphones according to the second embodiment of the present application.

FIG. 12 is a low chart of the method for matching left and right channels of earphones according to the second embodiment of the present application.

FIG. 13 is a schematic view of a wearing position of a clip-on earphone in a wearing state from one perspective.

FIG. 14 is a view of three-axis acceleration information when the clip-on earphones are worn on the left and right ears according to an embodiment of the present application.

The purpose, features and advantages of the present application will be further explained in conjunction with the embodiments and with reference to the accompanying drawings.

### DETAILED DESCRIPTION OF THE EMBODIMENTS

To make the above-mentioned objects, features, and advantages of the present application more clearly understood, the technical solutions in the embodiments of the present application will be clearly and completely described below in conjunction with the accompanying drawings of the embodiments of the present application. Obviously, the described embodiments are only some of the embodiments of the present application, not all of them. Based on the embodiments of the present application, all other embodiments obtained by those skilled in the art without making any creative efforts shall fall within the scope of protection of the present application.

The clip-on earphones include a left earphone and a right earphone. The left earphone outputs a left channel, while the right earphone outputs a right channel. When the stereo earphones are worn, the left earphone is in contact with the user's left ear, and the right earphone is in contact with the user's right ear, so that the left ear receives the left channel and the right ear receives the right channel. During wearing, the relative positions of the left earphone and the right earphone cannot be interchanged, otherwise it will directly affect the fidelity of the sound source and the resolution of the audio frequency.

To achieve perfect sound quality, users must first identify the left and right earphones of their clip-on earphones before putting them on. In the related art, the clip-on earphones are marked with identifiers such as “L” and “R.” However, this requires manual identification before wearing to avoid reversed placement, which brings inconvenience to the user.

### First Embodiment

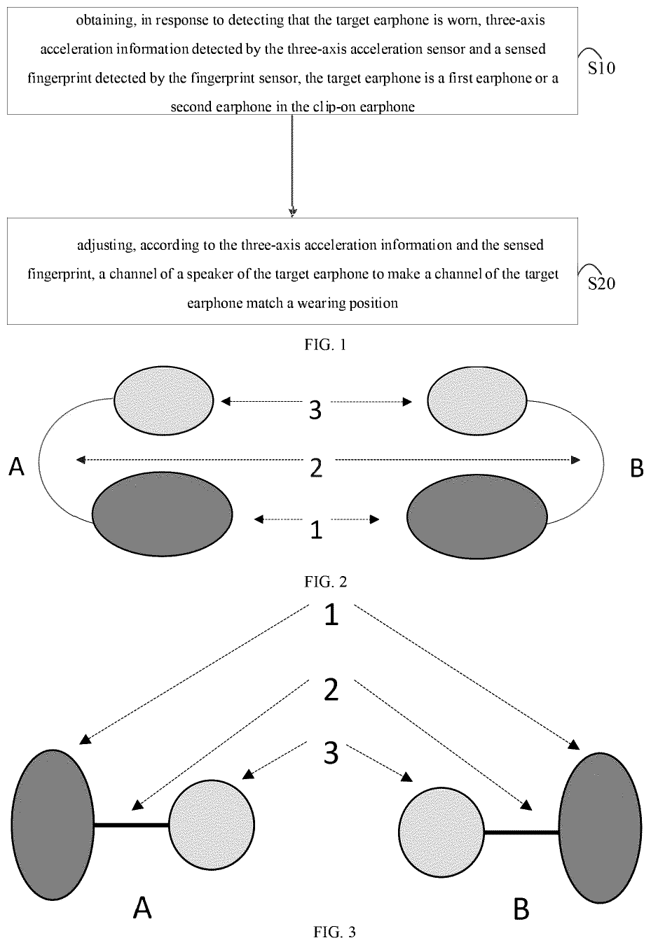

Based on this, as shown in FIG. 1, which is a flow chart of a method for matching left and right channels of earphones according to a first embodiment of the present application. The method for matching left and right channels of earphones is applied to a clip-on earphone. A target earphone of the clip-on earphone is provided with a three-axis acceleration sensor and a fingerprint sensor. The method includes Step S10 and Step S20.

Step S10, obtaining, in response to detecting that the target earphone is worn, three-axis acceleration information detected by the three-axis acceleration sensor and a sensed fingerprint detected by the fingerprint sensor, the target earphone is a first earphone or a second earphone in the clip-on earphone.

As those skilled in the art will appreciate, the clip-on earphones include two single earphones, namely a first earphone and a second earphone. As shown in FIG. 2 and FIG. 3, FIG. 2 is the clip-on earphone according to an embodiment of the present application from a perspective, and FIG. 3 is the clip-on earphone according to an embodiment of the present application from another perspective. An earphone includes a speaker compartment 3 and a behind-the-ear compartment 1, as well as a connecting bridge 2 connecting the speaker compartment 3 and the behind-the-ear compartment 1. The speaker compartment area refers to the area corresponding to the speaker compartment 3. As those skilled in the art will appreciate, the speaker compartment 3 of the clip-on earphone is typically provided with an acoustic module, which includes a speaker. The acoustic module may also include a microphone, but this is not limited in the embodiment. The behind-the-ear compartment 1 is provided with a power module for providing electrical energy. The behind-the-ear compartment 1 is also provided with a noise reduction module and a communication module, etc., but this is not limited in the embodiment. The speaker is used to play audio from the left or right channel, and the power module is used to provide electrical energy to the earphone. The communication module is used to enable the earphone to communicate with other electronic devices connected to the earphone for information exchange. The acceleration sensor is used to detect the three-axis acceleration information of the earphone. The microphone is used to collect ambient audio, and the noise reduction module is used to adaptively reduce the noise of the ambient audio collected by the microphone based on a preset noise reduction algorithm. The preset noise reduction algorithm can be an active noise control (ANC) algorithm, an environmental noise cancellation (ENC) algorithm, a digital signal processing (DSP) algorithm, or a clear voice capture (CVC) algorithm. Those skilled in the art have conducted in-depth research on these noise reduction algorithms and will not be elaborated on here.

In the embodiment, the hardware principle of the fingerprint sensor has been deeply studied by those skilled in the art and will not be described in detail here.

Those skilled in the art will know that a three-axis acceleration sensor works based on the basic principle of acceleration, and acceleration is a space vector.

Step S20, adjusting, according to the three-axis acceleration information and the sensed fingerprint, a channel of a speaker of the target earphone to make a channel of the target earphone match a wearing position.

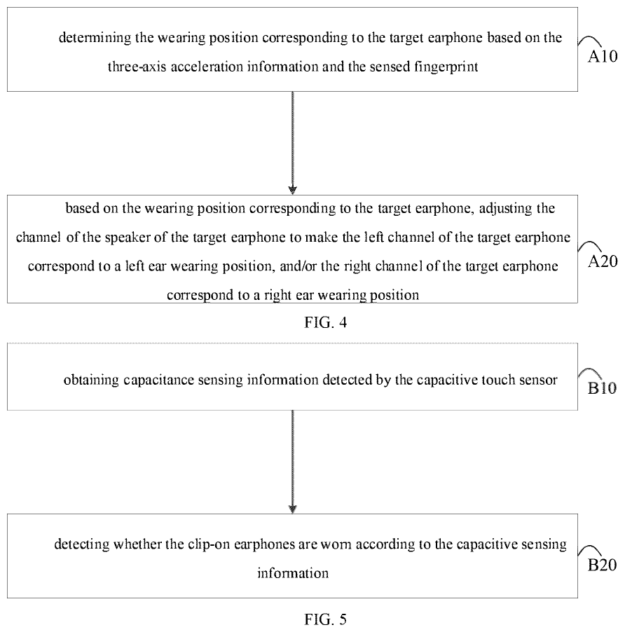

In an embodiment, as shown in FIG. 4, adjusting, according to the three-axis acceleration information and the sensed fingerprint, the channel of the speaker of the target earphone includes:

Step A10, determining the wearing position corresponding to the target earphone based on the three-axis acceleration information and the sensed fingerprint; and

Step A20, based on the wearing position corresponding to the target earphone, adjusting the channel of the speaker of the target earphone to make the left channel of the target earphone correspond to a left ear wearing position, and/or the right channel of the target earphone correspond to a right ear wearing position.

In the embodiment, the skin texture, including fingerprints, on each finger of a person's left and right hands differs in pattern, breakpoints, and intersections, making it unique and unchanging throughout life. Therefore, the fingerprints of each finger on the user's left and right hands can be associated with the left and right hands. By comparing fingerprint of each finger with the corresponding fingerprint data of the user's left and right hands that have been saved, the left and right hands can be determined. This is known as fingerprint recognition technology.

In an embodiment, the fingerprint sensor is a miniaturized fingerprint recognition module, which is set at a location where the user can pinch the earphone when picking up the earphone. Since the fingerprint sensor does not involve security issues, it only needs to roughly judge the finger features and does not require a standard fingerprint recognition unit, thus it can be implemented in a relatively small space inside the earphone.

In the embodiment, when the left and right channels of the target earphone are initialized, the fingerprint sensor of the target earphone may use fingerprint recognition technology to scan at least one finger of the user's left and right hands to collect fingerprint information. For example, the fingerprint sensor may scan at least one finger on the left hand, such as at least one of the thumb, index finger, middle finger, ring finger, and little finger. For ease of use, the fingerprint sensor scans fingerprints on the thumbs and/or index fingers of both hands. The fingerprint sensor then inputs the scanned fingerprint information into the processor of the target earphone. The processor inputs the fingerprint information to a display device communicatively connected to the clip-on earphone. The display device displays left and right channel selection options, such as “detecting fingerprint information, do you want to store it as left channel information?” or “detecting fingerprint information, do you want to store it as right channel information?”, for the user to select. The processor receives the left and right channel selection result and inputs the left and right channel selection result, as well as the correspondence between the left and right channels and the fingerprint, or the correspondence between the left and right channels and the left and right hands, into the memory of the earphone.

In an embodiment, the left and right channels of the earphones are initialized. After the initialization of the left and right channels of the earphones is completed, when the user uses the earphone, before the earphones are worn, when any finger of any hand pinches the target earphone, the fingerprint sensor collects the fingerprint information of the current user (i.e., the sensed fingerprint) and inputs it to the processor, and then the processor is used to configure the speaker corresponding to the target earphone to the left channel or the right channel according to the sensed fingerprint collected during use and the correspondence between the left channel and the right channel and the fingerprint stored in the memory. In an embodiment of the present application, the processor can also be used to determine whether the current finger is a finger of the left hand or a finger of the right hand according to the sensed fingerprint collected during use, and then configure the speaker corresponding to the target earphone to the left channel or the right channel according to the correspondence between the left and right channels and the left and right hands stored in the memory.

In the embodiment, the earphone automatically match the left and right channels with the left and right ears based on the different fingerprints collected each time the earphones are worn, thereby achieving the purpose of arbitrary wearing. That is, when the user is wearing the target earphone, any finger of any hand will pinch the surface of the target earphone. It is easy to understand that according to wearing habits, users generally use their left hand to wear the left earphone and their right hand to wear the right earphone. Therefore, the fingerprint sensor provided at the target earphone can collect the fingerprint information of the current user and input it to the processor. The processor is used to configure the speaker corresponding to the target earphone to the left channel or the right channel based on the correspondence between the fingerprint information and the left and right channels and the fingerprint information of the current finger used. In an embodiment, when the current user's sensed fingerprint is the left hand fingerprint, the speaker corresponding to the target earphone is configured to the left channel. When the current user's sensed fingerprint is the right hand fingerprint, the speaker corresponding to the target earphone is configured to the right channel.

It should be noted that if only the three-axis acceleration sensor is used to detect the three-axis acceleration information of the target earphone, and the corresponding wearing position of the target earphone is determined based on the three-axis acceleration information. For example, if a direction of the vertical component of the three-axis acceleration information points to the positive direction of the Z axis, then the wearing position corresponding to the target earphone is determined to be the first position, and if the direction of the vertical component of the three-axis acceleration information points to the negative direction of the Z axis, then the wearing position corresponding to the target earphone is determined to be the second position. If the wearing position is the first position, then the corresponding wearing position of the target earphone is determined to be the left ear wearing position. If the wearing position is the second position, the target earphone is determined to be in the right ear wearing position.

Based on the corresponding wearing positions of the first earphone and the second earphone, the left and right channels of the clip-on earphone's speaker are adjusted so that the left channel corresponds to the earphone in the left ear wearing position. However, the process of identifying the wearing position of the target earphone using only the three-axis acceleration sensor may result in misjudgment due to some special scenarios. For example, when a person wears the earphones, their head is not upright, but in an unconventional posture such as inverted or lying down. In this case, the wearing position of the target earphone cannot be accurately identified. In particular, when the head is in an inverted position, the identified wearing position is exactly the opposite, resulting in misidentification.

Based on this, the embodiment of the present application integrates the acceleration sensor information and the sensed fingerprint information of the target earphone, so that the user can wear the earphones in any posture and can detect them correctly and autonomously. The left and right ear channels will no longer change due to changes in the user's head movements, further improving the stability and robustness of the method for matching left and right channels of earphones in the embodiment of the present application.

In an embodiment, the target earphone includes a speaker compartment and a behind-the-ear compartment, and the fingerprint sensor includes a fingerprint detection sensing strip for fingerprint area sensing, and the fingerprint detection sensing strip is provided at the surface of the speaker compartment and/or behind-the-ear compartment.

In the embodiment, as shown in FIG. 3, the target earphone include a speaker compartment 3 and a behind-the-ear compartment 1, as well as a connecting bridge 2 connecting the speaker compartment 3 and the behind-the-ear compartment 1. The speaker compartment area refers to the area corresponding to the speaker compartment 3. Those skilled in the art will appreciate that for clip-on earphones, the speaker compartment 3 is generally provided with an acoustic module, and the behind-the-ear compartment 1 is generally provided with a communication unit and a power module, etc. (for example, the behind-the-ear compartment 1 or the speaker compartment 3 may also be provided with a noise reduction unit, etc.). The fingerprint detection sensing strip is provided at the surface of the speaker compartment 3 and/or the behind-the-ear compartment 1.

The embodiment of the present application provides an open-ear earphone that does not require the user to distinguish between the left and right ears when worn, and the earphone can independently identify the left and right channels when worn, thereby avoiding the trouble of the user having to distinguish between the left and right ears when wearing.

In an embodiment, as shown in FIG. 5, the first earphone and the second earphone are further provided with a capacitive touch sensor, and the method further includes:

Step B10, obtaining capacitance sensing information detected by the capacitive touch sensor; and

Step B20, detecting whether the clip-on earphones are worn according to the capacitive sensing information.

The present application obtains capacitance sensing information detected by a capacitive touch sensor, and accurately detects whether the clip-on earphones are worn based on the capacitance sensing information.

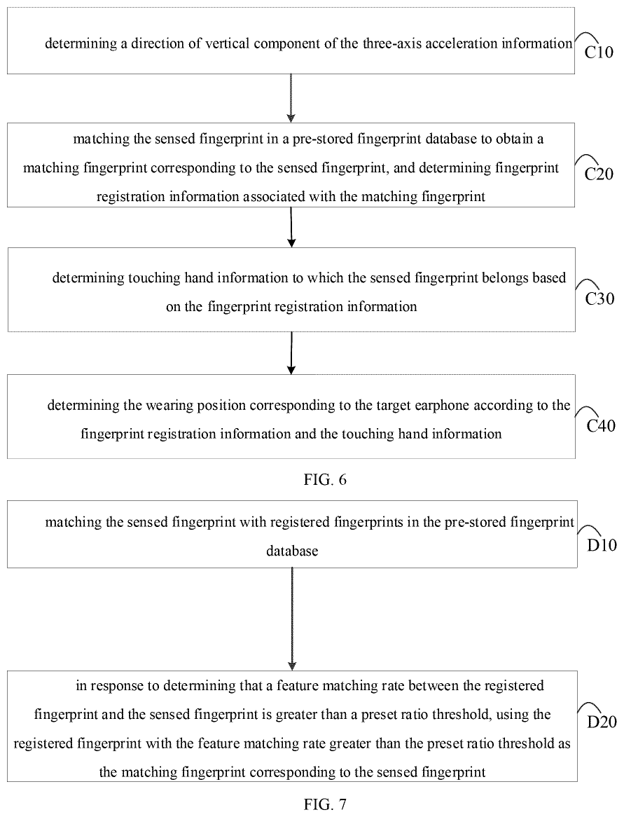

In an embodiment, as shown in FIG. 6, determining the wearing position corresponding to the target earphone based on the three-axis acceleration information and the sensed fingerprint includes:

Step C10, determining a direction of vertical component of the three-axis acceleration information, and

Step C20, matching the sensed fingerprint in a pre-stored fingerprint database to obtain a matching fingerprint corresponding to the sensed fingerprint, and determining fingerprint registration information associated with the matching fingerprint.

In an embodiment, as shown in FIG. 7, matching the sensed fingerprint with the pre-stored fingerprint database to obtain the matching fingerprint corresponding to the sensed fingerprint includes:

Step D10, matching the sensed fingerprint with registered fingerprints in the pre-stored fingerprint database; and

Step D20, in response to determining that a feature matching rate between the registered fingerprint and the sensed fingerprint is greater than a preset ratio threshold, using the registered fingerprint with the feature matching rate greater than the preset ratio threshold as the matching fingerprint corresponding to the sensed fingerprint.

After step C20, step C30 is executed, step C30, determining touching hand information to which the sensed fingerprint belongs based on the fingerprint registration information.

Step C40, determining the wearing position corresponding to the target earphone according to the fingerprint registration information and the touching hand information.

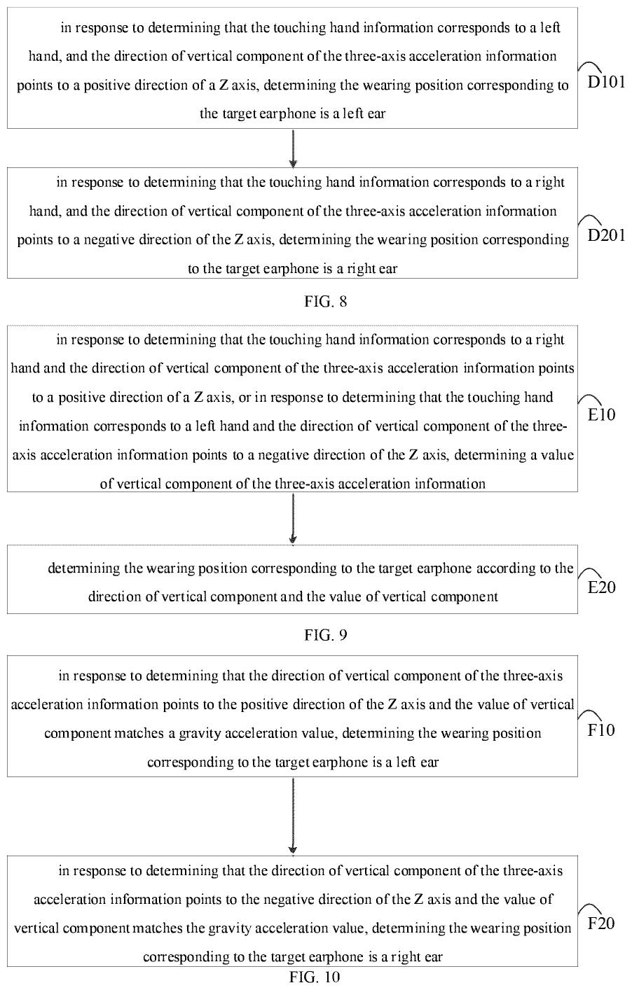

In an embodiment, as shown in FIG. 8, determining the wearing position corresponding to the target earphone according to the fingerprint registration information and the touching hand information includes:

Step D101, in response to determining that the touching hand information corresponds to a left hand, and the direction of vertical component of the three-axis acceleration information points to a positive direction of a Z axis, determining the wearing position corresponding to the target earphone is a left ear; and

Step D201, in response to determining that the touching hand information corresponds to a right hand, and the direction of vertical component of the three-axis acceleration information points to a negative direction of the Z axis, determining the wearing position corresponding to the target earphone is a right ear.

In the embodiment, the preset ratio threshold can be set according to actual conditions and is not limited in the embodiment. For example, the preset ratio threshold can be 95% or 98%.

The embodiment of the present application determines the direction of vertical component of the three-axis acceleration information, and matches the sensed fingerprint in a pre-stored fingerprint database to obtain a matching fingerprint corresponding to the sensed fingerprint, and determines the fingerprint registration information associated with the matching fingerprint. Then, based on the fingerprint registration information, the touching hand information to which the sensed fingerprint belongs is determined, and then according to the fingerprint registration information and the touching hand information, the wearing position corresponding to the target earphone is determined, thereby effectively improving the accuracy of identifying the wearing position of the earphone, and automatically matching the left and right channels with the left and right ears by having the left channel of the earphone correspond to the wearing position of the left ear, and the right channel of the earphone correspond to the wearing position of the right ear, thereby overcoming the inconvenience in the related art in which identifiers such as “L” and “R” are marked on the earphones and manual confirmation is required to avoid reverse wearing, thereby improving the convenience of using the clip-on earphones.

### Second Embodiment

Based on the first embodiment of the present application, in another embodiment of the present application, the same or similar contents as those in the above-mentioned first embodiment can be referred to the above introduction and will not be described in detail later. On this basis, as shown in FIG. 9, the method further includes:

Step E10, in response to determining that the touching hand information corresponds to a right hand and the direction of vertical component of the three-axis acceleration information points to a positive direction of a Z axis, or in response to determining that the touching hand information corresponds to a left hand and the direction of vertical component of the three-axis acceleration information points to a negative direction of the Z axis, determining a value of vertical component of the three-axis acceleration information; and

Step E20, determining the wearing position corresponding to the target earphone according to the direction of vertical component and the value of vertical component.

In an embodiment, as shown in FIG. 10, determining the wearing position corresponding to the target earphone according to the direction of vertical component and the value of vertical component includes:

Step F10, in response to determining that the direction of vertical component of the three-axis acceleration information points to the positive direction of the Z axis and the value of vertical component matches a gravity acceleration value, determining the wearing position corresponding to the target earphone is a left ear; and

Step F20, in response to determining that the direction of vertical component of the three-axis acceleration information points to the negative direction of the Z axis and the value of vertical component matches the gravity acceleration value, determining the wearing position corresponding to the target earphone is a right ear.

In the embodiment, since a person's head is generally in an upright position when wearing earphones (the head is rarely in a lying or upside-down position), the value of vertical component of Z axis generally matches the gravity acceleration value. Based on this principle, the embodiment of the present application determines that the wearing position corresponding to the target earphone is the left ear, if the direction of vertical component of the three-axis acceleration information of the target earphone points to the positive direction of the Z axis and the value of vertical component in the positive Z axis direction matches the gravity acceleration value; and determines that the wearing position corresponding to the target earphone is the right ear, if the direction of vertical component of the three-axis acceleration information of the target earphone points to the negative direction of the Z axis and the value of vertical component in the negative Z axis direction matches the gravity acceleration value, thereby further improving the accuracy of identifying the wearing position of the earphone. By corresponding the left channel to the left ear wearing position and the right channel to the right ear wearing position, the left and right channels of the earphones are automatically matched to the left and right ears. This further ensures that there is no need to distinguish between the left and right channels before wearing the earphones, and the sound signals of the left and right channels are always correct regardless of how the clip-on earphones are worn.

In an embodiment, as shown in FIG. 11, after determining the value of vertical component of the three-axis acceleration information, the method further includes:

Step G10, in response to determining that the value of vertical component matches a gravity acceleration value, determining the wearing position corresponding to the target earphone according to the direction of vertical component and the value of vertical component; and

Step G20, in response to determining that the value of vertical component does not match the gravity acceleration value, determining the wearing position corresponding to a reference earphone; determining the wearing position corresponding to the target earphone based on a wearing position corresponding to the reference earphone, the reference earphone is an earphone of another channel in the clip-on earphone corresponding to the target earphone.

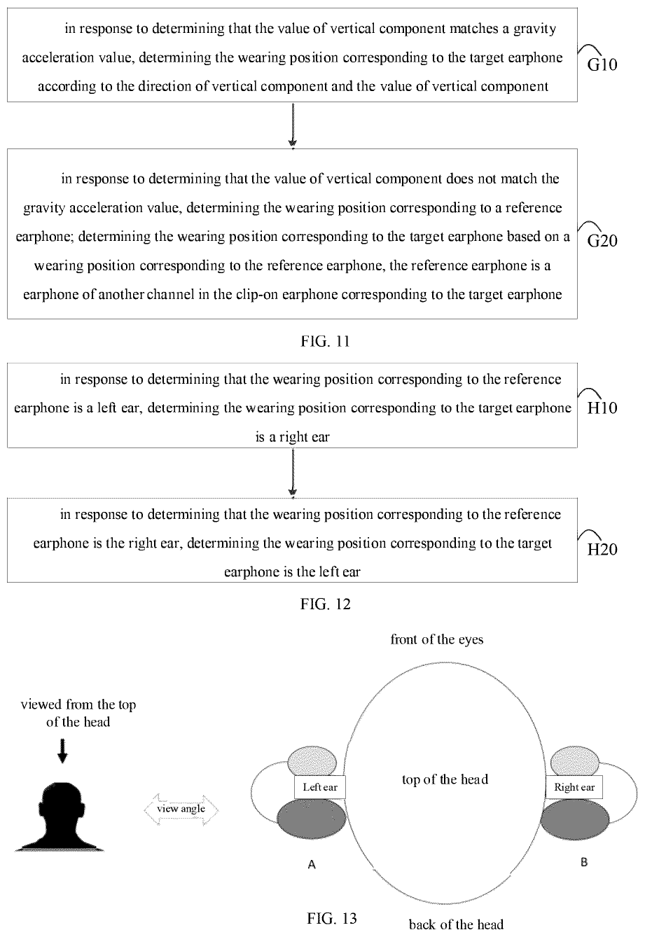

In an embodiment, as shown in FIG. 12, determining the wearing position corresponding to the target earphone based on the wearing position corresponding to the reference earphone includes:

Step H10, in response to determining that the wearing position corresponding to the reference earphone is a left ear, determining the wearing position corresponding to the target earphone is a right ear; and

Step H20, in response to determining that the wearing position corresponding to the reference earphone is the right ear, determining the wearing position corresponding to the target earphone is the left ear.

Since it is possible that even if one earphone is integrated with the acceleration sensor information and the sensed fingerprint information, it is still impossible to effectively detect the wearing position of the target earphone (for example, due to factors such as a sensor failure in earphone), the wearing position of another earphone can be combined to assist in determining the current wearing position of the target earphone. It is easy to understand that when both earphones are worn, if one earphone is worn on the left ear, another earphone must be worn on the right ear, and if one earphone is worn on the right ear, another earphone must be worn on the left ear.

Based on this, the embodiment of the present application determines the wearing position corresponding to the reference earphone when the value of vertical component does not match the gravity acceleration value, and determines the wearing position corresponding to the target earphone based on the wearing position corresponding to the reference earphone, the reference earphone is the earphone of another channel corresponding to the target earphone in the clip-on earphone. Therefore, when facing a certain earphone, even if the acceleration sensor information and the sensed fingerprint information are integrated, the wearing position of the target earphone cannot be effectively detected, and the wearing position of the earphone can be accurately identified, so that the left channel of the target earphone corresponds to the left ear wearing position, and the right channel of the target earphone corresponds to the right ear wearing position, so as to further ensure that the left and right channels are accurately and automatically correspond to the left and right ears.

In order to further help understand the technical concept of the present application, an embodiment is provided, including:

As shown in FIG. 13, FIG. 13 is a schematic view of the wearing position of the clip-on earphones in a wearing state from one perspective (viewed from the top of the head). The first earphone and the second earphone are identical, and there is no need to manually distinguish between the left and right ears, and the user can wear them at will. The earphones will automatically distinguish and configure the left and right channels based on the left and right sides of the user. Since the user's head is generally in an upright upward position when first worn, rather than lying down or inverted, the method for matching left and right channels of earphones of the embodiment of the present application can easily implement an autonomous detection solution for the left and right channels of open-type earphones, making it convenient for users to wear and use. The user no longer needs to distinguish between left and right, and can wear them blindly. In addition, the clip-on earphones of the embodiment of the present application have a simple structure, and the hardware cost of implementing the method for matching left and right channels of earphones is low.

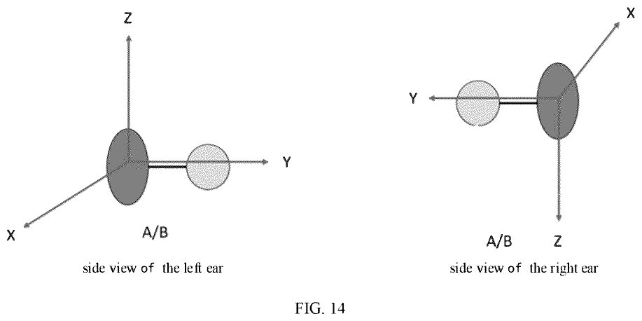

In an embodiment, an acceleration sensor can be provided in the behind-the-ear compartment, and the coordinates can be calibrated according to the normal wearing position when the earphones leave the factory. For example, the same coordinate calibration is performed on each earphone, and the Z axis is calibrated to point upwards in the normal wearing position. As shown in FIG. 14, which is a view of the three-axis acceleration information when the clip-on earphone is worn on the left and right ears in the embodiment of the present application, when the earphones are worn normally, it is detected that the Z axis points upwards as the left channel, as shown in FIG. 14, the side view of the left ear, and it is detected that the Z axis points downwards as the right channel, as shown in FIG. 14, the side view of the right ear. When the user wears the earphones in the correct posture, the Z axis of one earphone must point upwards and the Z axis of another earphone must point downwards to complete the left and right channel configuration. After the clip-on earphones leave the factory, the left and right channel identification needs to be completed in conjunction with the wearing detection function of the acceleration sensor data of the earphones.

If the user wears the earphone in an abnormal posture, such as lying down or standing upside down, relying solely on the acceleration sensor may cause misjudgment and fail to accurately configure the left and right channels.

The embodiment adds a miniature fingerprint sensor in the behind-the-ear compartment. When the user uses the product for the first time, the user needs to complete the fingerprint entry corresponding to the left and right ear for each earphone. The fingerprint detection strip of the fingerprint sensor is located in a position where the user's fingers can easily pick up when taking the earphones out of the charging box, so that the fingerprint recognition of the left and right hands can be completed while the user is taking the earphones.

According to wearing habits, the left earphone is usually worn on the left ear and the right earphone is worn on the right ear. For clip-on earphones, it is difficult to wear the right earphone on the left hand or the left earphone on the right hand.

From the moment the earphones are taken out of the charging box to the moment they are put on, the acceleration sensor detects the coordinates and recognizes the fingerprint, so that the left and right channels can be correctly configured in any free posture of the user.

In addition, left and right channel recognition needs to be completed in conjunction with the wearing detection function of the earphones, and recognition can be completed during the wearing process. During the user's wearing and use, the left and right ear channels will no longer change due to changes in the user's head movement.

It should be noted that the embodiment is only used to understand the technical concept of the present application and does not constitute a limitation of the present application. More simple forms of transformation based on the technical concept of the present application should all be within the scope of protection of the present application.

### Third Embodiment

An embodiment of the present application provides a clip-on earphone, including a memory, a processor, a fingerprint sensor, a behind-the-ear compartment, a speaker compartment, and a connecting bridge connecting the behind-the-ear compartment and the speaker compartment. The speaker compartment is provided with an acoustic module including a speaker, the behind-the-ear compartment is provided with a power module and an acceleration sensor, and the fingerprint sensor is provided in the speaker compartment and/or the behind-the-ear compartment.

The power module is configured to provide power to the clip-on earphone; the acceleration sensor is configured to detect the three-axis acceleration information of the clip-on earphone; the fingerprint sensor is configured to detect the sensed fingerprint; the memory is configured to store a program for matching left and right channels of earphones; the processor is configured to execute the program for matching left and right channels of earphones, and implement the method for matching left and right channels of earphones as described in the above embodiment when executing the program for matching left and right channels of earphones.

The clip-on earphones provided by the present application utilize the method for matching left and right channels of earphones described in the aforementioned embodiment, which can solve the technical problem of poor convenience of clip-on earphones in the related art, such as the need to manually confirm whether the left and right earphones are worn reversed. Compared with the related art, the clip-on earphones provided by the present application achieve the same beneficial effects as the method for matching left and right channels of earphones described in the aforementioned embodiment. Other technical features of the clip-on earphones are the same as those disclosed in the aforementioned embodiment and are not further elaborated upon here.

It should be understood that various parts of the present application can be implemented with hardware, software, firmware or a combination thereof. In the description of the above embodiments, specific features, structures, materials or characteristics can be combined in any one or more embodiments or examples in an appropriate manner.

The above are merely some embodiments of the present application, but the scope of protection of the present application is not limited thereto. Any modifications or substitutions that can be easily conceived by a person skilled in the art within the technical scope disclosed in the present application should be included in the scope of protection of the present application. Therefore, the scope of protection of the present application should be based on the scope of protection of the claims.

### Fourth Embodiment

An embodiment of the present application provides a computer-readable storage medium storing computer-readable program instructions thereon, and the computer-readable program instructions are used to execute the method for matching left and right channels of earphones in the above embodiments.

The computer-readable storage medium provided in the embodiments of the present application may be, for example, a USB flash drive, but is not limited to electrical, magnetic, optical, electromagnetic, infrared, or semiconductor systems, systems, or devices, or any combination thereof. More specific examples of computer-readable storage media may include, but are not limited to, an electrical connection having one or more wires, a portable computer disk, a hard disk, random access memory (RAM), read-only memory (ROM), erasable programmable read-only memory (EPROM or flash memory), optical fiber, a portable compact disk read-only memory (CD-ROM), an optical storage device, a magnetic storage device, or any suitable combination thereof. In the embodiment, the computer-readable storage medium may be any tangible medium that contains or stores a program that can be used by or in conjunction with an instruction execution system, system, or device. The program code contained on the computer-readable storage medium may be transmitted using any suitable medium, including but not limited to wires, optical cables, radio frequency (RF), etc., or any suitable combination thereof.

The computer-readable storage medium may be included in the clip-on earphone, or may exist independently without being assembled in the clip-on earphone.

The computer-readable storage medium carries one or more programs. When the one or more programs are executed by the clip-on earphones, the process are as follows: in response to detecting that the target earphone is worn, obtaining three-axis acceleration information detected by the three-axis acceleration sensor and a sensed fingerprint detected by the fingerprint sensor, the target earphone is a first earphone or a second earphone in the clip-on earphone; and according to the three-axis acceleration information and the sensed fingerprint, adjusting a channel of a speaker of the target earphone to make a channel of the target earphone match a wearing position.

Computer program code for performing the operations of the present application may be written in one or more programming languages, or a combination thereof, including object-oriented programming languages such as Java, Smalltalk, C++, and conventional procedural programming languages such as “C” or similar programming languages. The program code may be executed entirely on the user's computer, partially on the user's computer, as a stand-alone software package, partially on the user's computer and partially on a remote computer, or entirely on a remote computer or server. In cases involving a remote computer, the remote computer may be connected to the user's computer through any type of network, including a local area network (LAN) or a wide area network (WAN), or may be connected to an external computer (e.g., through the Internet using an Internet service provider).

The flow charts and block views in the accompanying drawings illustrate the possible implementation architecture, functions and operations of the system, method and computer program product according to various embodiments of the present application. In this regard, each box in the flow chart or block view can represent a module, program segment, or a part of code, and the module, program segment, or a part of code contains one or more executable instructions for realizing the specified logical function. It should also be noted that in some alternative implementations, the functions marked in the box can also occur in a different order than that marked in the accompanying drawings. For example, two boxes represented in succession can actually be executed substantially in parallel, and they can sometimes be executed in the opposite order, depending on the functions involved. It should also be noted that each box in the block view and/or flow chart, and the combination of the boxes in the block view and/or flow chart, can be implemented with a dedicated hardware-based system that performs the specified function or operation, or can be implemented with a combination of dedicated hardware and computer instructions.

The modules involved in the embodiments described in the present application may be implemented in software or hardware, the name of a module does not necessarily limit the unit itself.

The computer-readable storage medium provided by the present application stores computer-readable program instructions for executing the aforementioned method for matching left and right channels of earphones. This solves the technical problem in the related art of requiring manual confirmation of whether the left and right earphones are worn reversed, resulting in poor usability of clip-on earphones. Compared to the related art, the beneficial effects of the computer-readable storage medium provided by the embodiments of the present application are the same as those of the method for matching left and right channels of earphones provided by the aforementioned first embodiment or second embodiment, and are not further elaborated here.

### Fifth Embodiment

An embodiment of the present application further provides a computer program product, including a computer program, which implements the steps of the above-mentioned method for matching left and right channels of earphones when executed by a processor.

The computer program product provided by the present application can solve the technical problem of poor convenience of clip-on earphones in the related art, such as the need to manually confirm whether the left and right earphones are worn reversed. Compared with the related art, the beneficial effects of the computer program product provided by the embodiments of the present application are the same as those of the method for matching left and right channels of earphones provided by the above-mentioned first embodiment of second embodiment, and will not be further elaborated here.

The above are only some embodiments of the present application and do not limit the patent scope of the present application. Any equivalent structure or equivalent process transformation made using the contents of the present application specification and drawings, or directly or indirectly applied in other related technical fields, are also included in the patent processing scope of the present application.

What is claimed is:

1. A method for matching left and right channels of earphones, applied to a clip-on earphone, wherein a target earphone of the clip-on earphone is provided with a three-axis acceleration sensor and a fingerprint sensor, the method comprising:
obtaining, in response to detecting that the target earphone is worn, three-axis acceleration information detected by the three-axis acceleration sensor and a sensed fingerprint detected by the fingerprint sensor, wherein the target earphone is a first earphone or a second earphone in the clip-on earphone; and
adjusting, according to the three-axis acceleration information and the sensed fingerprint, a channel of a speaker of the target earphone to make a channel of the target earphone match a wearing position.

2. The method according to claim 1, wherein the adjusting, according to the three-axis acceleration information and the sensed fingerprint, the channel of the speaker of the target earphone comprises:
determining the wearing position corresponding to the target earphone based on the three-axis acceleration information and the sensed fingerprint; and
based on the wearing position corresponding to the target earphone, adjusting the channel of the speaker of the target earphone to make the left channel of the target earphone correspond to a left ear wearing position, and/or the right channel of the target earphone correspond to a right ear wearing position.

3. The method according to claim 2, wherein the determining the wearing position corresponding to the target earphone based on the three-axis acceleration information and the sensed fingerprint comprises:
determining a direction of vertical component of the three-axis acceleration information;
matching the sensed fingerprint in a pre-stored fingerprint database to obtain a matching fingerprint corresponding to the sensed fingerprint, and determining fingerprint registration information associated with the matching fingerprint;
determining touching hand information to which the sensed fingerprint belongs based on the fingerprint registration information; and
determining the wearing position corresponding to the target earphone according to the fingerprint registration information and the touching hand information.

4. The method according to claim 3, wherein the determining the wearing position corresponding to the target earphone according to the fingerprint registration information and the touching hand information comprises:
in response to determining that the touching hand information corresponds to a left hand, and the direction of vertical component of the three-axis acceleration information points to a positive direction of a Z axis, determining the wearing position corresponding to the target earphone is a left ear; and
in response to determining that the touching hand information corresponds to a right hand, and the direction of vertical component of the three-axis acceleration information points to a negative direction of the Z axis, determining the wearing position corresponding to the target earphone is a right ear.

5. The method according to claim 3, further comprising:
in response to determining that the touching hand information corresponds to a right hand and the direction of vertical component of the three-axis acceleration information points to a positive direction of a Z axis, or in response to determining that the touching hand information corresponds to a left hand and the direction of vertical component of the three-axis acceleration information points to a negative direction of the Z axis, determining a value of vertical component of the three-axis acceleration information; and
determining the wearing position corresponding to the target earphone according to the direction of vertical component and the value of vertical component.

6. The method according to claim 5, wherein the determining the wearing position corresponding to the target earphone according to the direction of vertical component and the value of vertical component comprises:
in response to determining that the direction of vertical component of the three-axis acceleration information points to the positive direction of the Z axis and the value of vertical component matches a gravity acceleration value, determining the wearing position corresponding to the target earphone is a left ear; and
in response to determining that the direction of vertical component of the three-axis acceleration information points to the negative direction of the Z axis and the value of vertical component matches the gravity acceleration value, determining the wearing position corresponding to the target earphone is a right ear.

7. The method according to claim 5, wherein the after determining the value of vertical component of the three-axis acceleration information, the method further comprises:
in response to determining that the value of vertical component matches a gravity acceleration value, determining the wearing position corresponding to the target earphone according to the direction of vertical component and the value of vertical component; and
in response to determining that the value of vertical component does not match the gravity acceleration value, determining the wearing position corresponding to a reference earphone;
determining the wearing position corresponding to the target earphone based on a wearing position corresponding to the reference earphone, wherein the reference earphone is an earphone of another channel in the clip-on earphone corresponding to the target earphone.

8. The method according to claim 7, wherein the determining the wearing position corresponding to the target earphone based on the wearing position corresponding to the reference earphone comprises:
in response to determining that the wearing position corresponding to the reference earphone is a left ear, determining the wearing position corresponding to the target earphone is a right ear; and
in response to determining that the wearing position corresponding to the reference earphone is the right ear, determining the wearing position corresponding to the target earphone is the left ear.

9. The method according to claim 3, wherein the matching the sensed fingerprint with the pre-stored fingerprint database to obtain the matching fingerprint corresponding to the sensed fingerprint comprises:
matching the sensed fingerprint with registered fingerprints in the pre-stored fingerprint database; and
in response to determining that a feature matching rate between the registered fingerprint and the sensed fingerprint is greater than a preset ratio threshold, using the registered fingerprint with the feature matching rate greater than the preset ratio threshold as the matching fingerprint corresponding to the sensed fingerprint.

10. The method according to claim 1, wherein the target earphone comprises a speaker compartment and a behind-the-ear compartment, and the fingerprint sensor comprises a fingerprint detection sensing strip for fingerprint area sensing, and the fingerprint detection sensing strip is provided at a surface of the speaker compartment and/or the behind-the-ear compartment.

11. A clip-on earphone, comprising:
a memory, a processor, a fingerprint sensor, a behind-the-ear compartment, a speaker compartment, and a connecting bridge connecting the behind-the-ear compartment and the speaker compartment, wherein:
the speaker compartment is provided with an acoustic module comprising a speaker, the behind-the-ear compartment is provided with a power module and an acceleration sensor, and the fingerprint sensor is provided in the speaker compartment and/or the behind-the-ear compartment;
the power module is configured to provide power to the clip-on earphone;
the acceleration sensor is configured to detect the three-axis acceleration information of the clip-on earphone;
the fingerprint sensor is configured to detect the sensed fingerprint;
the memory is configured to store a program for matching left and right channels of earphones;
the processor is configured to execute the program for matching left and right channels of earphones, and implement the method for matching left and right channels of earphones according to claim 1 when executing the program for matching left and right channels of earphones.

12. A non-transitory computer-readable storage medium, on which a program for implementing a method for matching left and right channels of earphones is stored, wherein when the program for implementing the method for matching left and right channels of earphones is executed by a processor, the method for matching left and right channels of earphones according to claim 1 is implemented.
